(19) United States
(12) Patent Application Publication
(10) Pub. No.: US 2011/0265163 A1
(43) Pub. Date: Oct. 27, 2011

(54) METHODS AND SYSTEMS FOR USER INTEGRATION

(76) Inventors: Val M. Mahanor, Virginia Beach, VA (US); John Burrows, Virginia Beach, VA (US)

(21) Appl. No.: 12/764,744

(22) Filed: Apr. 21, 2010

(51) Int. Cl. G06F 21/20; G06F 15/16

(52) U.S. Cl. 726/7

(57) ABSTRACT

Methods and systems for user integration are described. In an example embodiment, a method for user integration comprises accessing a network identifier of a user and user job data of the user from a user database, accessing credential data of the user from a credential database, using the network identifier to access an administrative network identifier associated with the user, a status of a user administrative account associated with the user, an administrative user name associated with the user, and a security template identifier associated with the user, transmitting user information to a collaboration site, the user information including the network identifier of the user, the user job data of the user, the administrative network identifier associated with the user, and the security template identifier, populating a roster on the collaboration site.

### FIELD

This application relates to methods and systems for integrating users into an existing computing system.

### BACKGROUND

Healthcare organizations may use software provided by a software application provider to access electronic medical records (EMR). In general, personnel associated with the healthcare organization undergo training to be able to use the EMR software.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an example, a computerized method, and system for tracking user integration, can include accessing a network identifier of a user and user job data of the user from a user database, accessing credential data of the user from a credential database, using the network identifier to access an administrative network identifier associated with the user, a status of a user administrative account associated with the user, an administrative user name associated with the user, and a security template identifier associated with the user, the administrative network identifier enabling access to software provided by a software application provider, the security template identifier identifying a security access level of the user with the software application provider, transmitting user information to a collaboration site, the user information including the network identifier of the user, the user job data of the user, the administrative network identifier associated with the user, and the security template identifier, and populating a roster on the collaboration site with the network identifier of the user, the user job data of the user, the administrative network identifier associated with the user, the security template identifier, and training task status of the user with a plurality of training tasks.

In further examples, the above methods steps are stored on a machine-readable medium comprising instructions, which when implemented by one or more processors perform the steps. In yet further examples, subsystems or devices can be adapted to perform the recited steps. Other features, examples, and embodiments are described below.

### BRIEF DESCRIPTION OF DRAWINGS

Embodiments are illustrated by way of example and not limitation in the figures of the accompanying drawings, in which like references indicate similar elements and in which:

FIG. 1 is a schematic diagram of a system according to an example embodiment;

FIG. 2 is a block diagram of a device according to an example embodiment;

FIG. 3 is a block diagram of a device according to an example embodiment;

FIG. 4 is a block diagram of a device according to an example embodiment;

FIG. 5 is a block diagram of a device according to an example embodiment;

FIG. 6 is a block diagram of a subsystem according to an example embodiment;

FIG. 7 is a block diagram of a subsystem according to an example embodiment;

FIG. 8 is a flow chart of a method according to an example embodiment;

FIG. 9 is a block diagram of views according to an example embodiment;

FIG. 10 is a flow chart of a method according to an example embodiment;

FIG. 11 is a flow chart of a method according to an example embodiment;

FIG. 12 is a user interface according to an example embodiment;

FIG. 13 is a user interface according to an example embodiment; and

FIG. 14 is a schematic view of a computing subsystem according to an example embodiment.

### DETAILED DESCRIPTION

Example methods and systems for user integration are described. In the following description, for purposes of explanation, numerous specific details are set forth in order to provide a thorough understanding of example embodiments. It will be evident, however, to one skilled in the art that the present invention may be practiced without these specific details.

In some example embodiments, methods and systems for user integration can enable a number a number of users of an entity to be brought online with a software application provider more quickly and in a more organized and efficient manner.

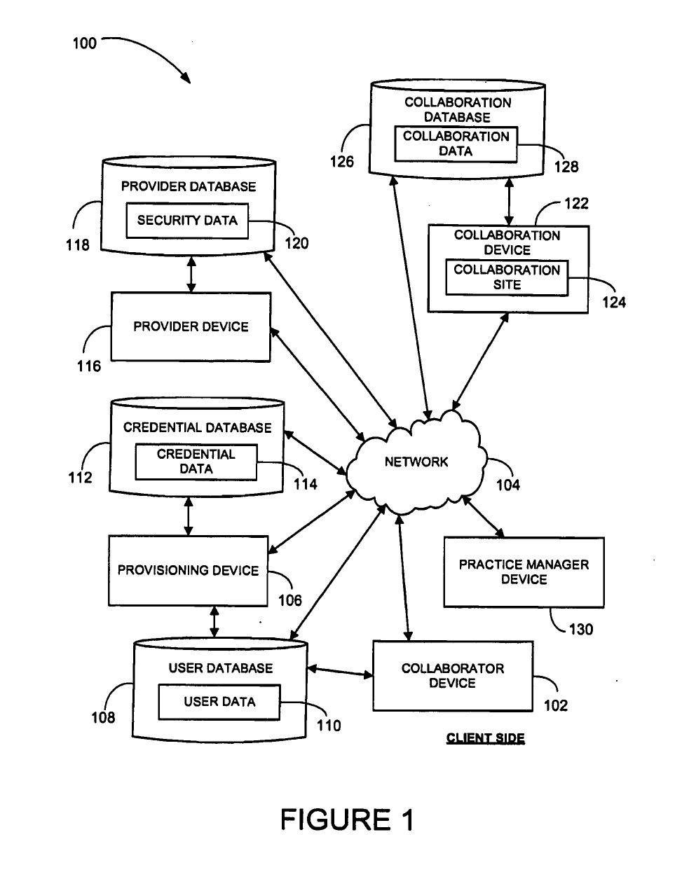

FIG. 1 illustrates an example system 100 that may be used to bring a number of users associated with an entity online with a software application provider. For example, the users may be associated with a healthcare organization (e.g., employees of a hospital or contractors working at a hospital) and the software application providth er may provide software that enables use of electronic medical records (EMR) by the users of the healthcare orgainization. The software may manage all clinical information, encounters, physician orders, and other information associated with the delivery of healthcare. For example, the EMR software may include EPIC by Epic Systems Corporation. In this example, Epic Systems Corporation is the software application provider. In some embodiments, the software application provider is the vendor of the software. Other software used in the system 100, such as billing software, may integrate with or be integral with EMR software provided by the software application provider.

In some embodiments, the system 100 uses active directory or another type of security layer for authorization and authentication of the users. With proper authorization and authentication, the users can access the EMR software. In some embodiments, a network identifier and password for the security layer provides a central source for user authentication and authorization in the system 100. Other security may, in addition to the security layer, be included on various devices of the system 100.

A collaborator may use a collaborator device 102 in the system 100 to communicate over a network 104 with a number of devices 106, 116, 122, 130 and databases 108, 112, 118, 126 to enable the users associated with the entity to come online with the software application provider. The devices include a provisioning device 106, a provider device 116, and a collaboration device 122. The databases include a user database 108, a credential database 112, a provider database 118, and a collaboration database 126. Other databases and devices may also be included in the system 100.

By coming online, the users are able to use the EMR software and/or other software provided by the software application provider. The system 100 may have a single collaborator using a single collaborator device, our multiple collaborators each using respective collaborator devices, multiple collaborators sharing one or more collaborator devices, or the like. The collaborators may include a security analyst that manages user integration and workflow. Other collaborators may be team members that are otherwise involved with the workflow (e.g., scheduling users for training). In general, the security analyst is involved with the workflow associated with the creation of the roster and other collaborators are involved with the workflow once the roster is created.

In some embodiments, the collaborator enables the users associated with the entity to come online with the software application provider by creating and refreshing a roster of the users. The collaborator and others manage the training and credentialing of the users by using the roster. When the users come online with the software application provider, the users are able to use the EMR or other software of the software application provider.

Examples of the network 104 by which the devices 102, 106, 116, 122, 130 and/or the databases 108, 112, 118, 126 communicate include Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof. Other conventional and/or later developed wired and wireless networks may also be used.

The provisioning device 106 provides an interface to allow for initiation of provisioning. In general, provisioning includes a set of business rules that decides how a person is set up as a user in the system 100. For example, provisioning a user includes a set of logic and rules that, based on the collection of data, feeds information through to certain devices connected through the network 104 about the user, provides security access to the user, transmits information to the software application provider about the user to enable the user to obtain access to the EMR software, or the like.

In some embodiments, the provisioning device 106 enables the collaborator to perform certain functionality separate from the collaborator device 102. For example, the provisioning device 106 may link certain data and the operate device 102 may create and refresh the roster. The collaborator device 102 and the provisioning device 106 may be a client-server relationship, a peer-to-peer relationship, or a different relationship. In one embodiment, the bulk of the functionality is deployed on the provisioning device 106. In another embodiment, the collaborator device 102 operates as a thin client and the bulk of the functionality is deployed on the provisioning device 106. The collaborator device 102 and the provisioning device 106 may otherwise be configured.

The operations performed on the provisioning device 106 may operate exclusively in the foreground, exclusively in the background, or a portion of the operations may be performed in the foreground while a remaining portion of the operations may be performed in the background.

To bring the users of the entity online with the software application provider, information regarding the users of the entity is obtained from the user database 108. The user database 108 stores user data 110 for the users of the entity. The user data 110 may be stored in form of records for the users, or may otherwise be stored.

The user database 108 may include a human resources (HR) database, job data, and/or a provisioning database of the entity and/or the collaborator. For example, an HR department of the entity may maintain the user database 108 on behalf of a number of its employees and/or contractors.

The collaborator, in one embodiment, receives the user database 108 from the entity or a person operating the user database 108 on behalf of the entity. The user database 108 may otherwise be available to the collaborator in the system 100. In some embodiments, the user database 108 is converted into an integrated format to enable access to the user data 110. For example, the conversion may occur when the user database 108 is not in a readable or compatible format for the requestor of the user data 110.

In some embodiments, the user data 110 includes a network identifier and user job data. The user data 110 is typically stored for a number of users such that each user has his or her own network identifier and user job data. In some embodiments, the network identifier uniquely identifies a user within a repository. As described below, the network identifier may be used to link a user in the system 110. The user job data is a set of information regarding the users. The user job data may include information regarding a number of users including, by way of example, a department, a job title, a UDAK, a clinical title, a location, a department, a job code, and/or a job title associated with the users. The user job data may be used as described below for mapping a user to an appropriate template and/or providing them with an appropriate level of access in the system 100.

In some embodiments, the collaborator or a device (e.g., the collaborator device 102) may make a determination as to whether a user has been added to or removed from the user data 110. When it is determined that the user data 110 has been changed based on the addition or removal of a user, a roster refresh instruction may be sent (e.g., from the collaborator device 102) to the collaboration site 124 as described in greater detail below.

The collaborator device 102 and/or the provisioning device 106 may access credential data 114 from the credential database 112. The credential data 114 indicates where physicians and other healthcare personnel of the entity are licensed. The credential data 114 may identify whether the physician has either admitting or attending privileges for the entity. The credential data 114, in some embodiments, validates that a user who is a physician has been credentialed, licensed, or otherwise approved to practice with entities associated with the collaborator. The credential data 114 may include NPI (National Provider ID) numbers for billing. As described in greater detail below, the credential data may be used to validate data elements (e.g., whether a user if licensed) provided by the software application provider.

The credential data 114 may include entity name, physician name, license number, DEA number, NPI number, UPIN number, demographics, contact information, or the like.

In some embodiments, the provisioning device 106 links the credential data 114 with the user data 110. The links associates a user with respective information about the user in the system 100. In one embodiment, a link identifies a particular user from the user data 110 with associated information from the credential data 114 about the user. For example, a link may identify the particular user as being a physician or as otherwise having credentials. The link may also uniquely identify the user (e.g., through a unique identifier). In some embodiments, linking the credential data 114 and the user data 110 enriches the information available about users of the system 100. By the linking, new relationships can be identified based on the integration of the data 110, 114 through the link. The linking may be created prior to the roster being created, during roster creation, and/or after roster creation.

In some embodiments, the administrative login identifier and provider password for a particular user of the provider device 116 are the same as the collaboration login identifier and collaboration password for the collaboration site 124. In an example embodiment, the login identifiers (or user names) and password may be for an active directory by which the devices of the system 100 may be accessed based on security level. By use of the same login identifier and password, the collaboration site 124 can link a record of the user stored in the user data 110 with the credential data 114 of the user. Information on the user can then automatically be brought into the collaboration site 124 based on the linking.

In some embodiments, an interface brings credential data 114 for a user that did not previously have credential data 114 and matches this user with the user data 110 of the user. For example, NPI numbers for physicians or social security numbers and dates of birth may be used to match the credential data 114 with the associated user.

In other embodiments, the user data 110 and the credential data 114 are not linked but are otherwise associated.

The software application provider may operate the provider device 116 and the provider database 118. In general, the software application provider offer EMR software (e.g., for healthcare organizations) from the provider device 116. The software provided by the software application provider may be operated server-side on the provider device 116, operated client-side (e.g., on the collaborator device 102), or may be operated partially client-side and partially server-side. In one embodiment, the software application provider is Epic Systems Corporation.

The software application provider stores security data 120 in the provider database 118. In some embodiments, the security data 120 includes an employee number, a network identifier, a template number, a provider identifier, and a software application provider status. In one embodiment, the provider database 118 is a CLARITY database. As used in the system 100, the provider database 118 may remain under control of the software application provider, be under the exclusive control of the collaborator, or may partially be under the control of the software application provider and partially under the control of the collaborator. For example, the security data 120 may be taken from a security master file maintained by the software application provider.

In some embodiments, an administrative query is made to the provider database 118 when portions of the security data 120 are desired. In others embodiments, the provider device 116 runs a report on the provider database 118 to create a reporting extract from the security data 120. The results of the query or report may be provided back to the requestor, to the collaboration site 124, or may otherwise be provided.

The collaboration site 124 operates on the collaboration device 122. In general, the collaboration site 124 is capable of having forms and workflows that can operate on a list of data or a roster. The collaboration site 124 may be a MICROSOFT SHAREPOINT site or a different type of collaboration site.

The collaboration site 124 may include a single roster or a number of rosters each of which reflects users associated with an entity and information associated with bringing the users onboard with the practice management software offered by the software application provider. In some embodiments, the collaboration site 124 has workflows created based on the roster. These workflows are tasks associated with bringing the entity onboard for implementation of technology associated with the software application provider.

In some embodiments, a dashboard is created based on the information stored in the roster that enables monitoring of user metrics of the users associated with the entity. For example, one user metric that may be displayed in the dashboard is the number of the users that need training.

In some embodiments, at least some of the users of the system 100 may be assigned security templates. In general, the security template is a template that holds security settings for a particular user type. When a user is brought into the system 100, the user may be assigned a particular security template that holds the security settings that correlate to the job role of the user. In one embodiment, each physician specialty may have its own security template.

The roster and/or the master template may be stored as collaboration data 128 in the collaboration database 126. The collaboration data 128 may include a single roster or multiple rosters and a single master template or multiple master templates. Each roster and master template may be associated with a single entity that has a number of users that seek to be brought online with the software application provider.

In some embodiments, a practice manager operates a practice manager device 130 in the system 100. In general, the practice manager is a person that manages the practice of a group of doctors. This group of doctors typically does not work for a hospital but may use hospital facilities to perform procedures.

The practice manager may use the practice manager device 130 to administer members of a medical practice (e.g., a doctor or a nurse) to enable them to have access to the system 100. The practice manager may use the practice manager device 130 to facilitate data searches. For example, the practice manager may use the practice manager device 130 to locate a doctor in a particular location with certain office hours. The practice manager device 130 may be used to perform security audits to ensure that all members that are currently registered with the system 100 still should have access to the system 100.

The practice manager may request changes including the addition of users to an existing practice and updating of information (e.g., practice information, office hours, telephone numbers, and locations). The changes may be requested through a web interface or may otherwise be requested. For example, the practice manager requests the changes through an administrative view.

Upon receiving the requested changes, the practice manager device 130 initiates a single workflow request or multiple workflow requests that appear on the collaborator device 102 to request validation of the changes. Once validated by the collaborator, the appropriate changes are made in the system 100. For example, the user data 110 may be changed based on the validation.

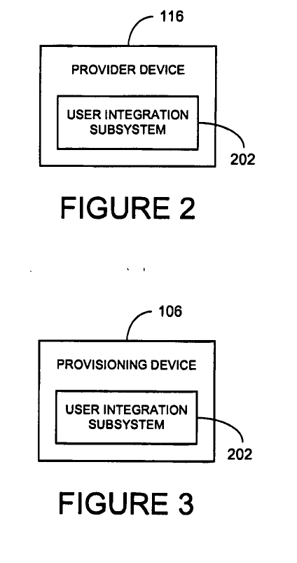

FIG. 2 illustrates an example provider device 116 that may be deployed in the system 100 (see FIG. 1), or otherwise deployed in another system. The provider device 116 is shown to include a user integration subsystem 202 to enable a number of users of the entity to be able to use software provided by the software application provider.

FIG. 3 illustrates an example provisioning device 106 that may be deployed in the system 100 (see FIG. 1), or otherwise deployed in another system. The provisioning device 106 is shown to include a user integration subsystem 202 to enable a number of users of the entity to be able to use software provided by the software application provider.

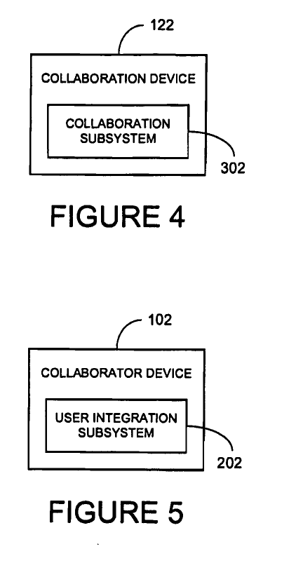

FIG. 4 illustrates an example collaboration device 122 that may be deployed in the system 100 (see FIG. 1), or otherwise deployed in another system. The collaboration device 122 is shown to include a collaboration subsystem 302 to collaborate the workflow used to bring a number of users online with the software application provider.

FIG. 5 illustrates an example collaborator device 102 that may be deployed in the system 100 (see FIG. 1), or otherwise deployed in another system. The collaborator device 102 is shown to include a user integration subsystem 202 to enable a number of users of the entity to be associated with a healthcare management system.

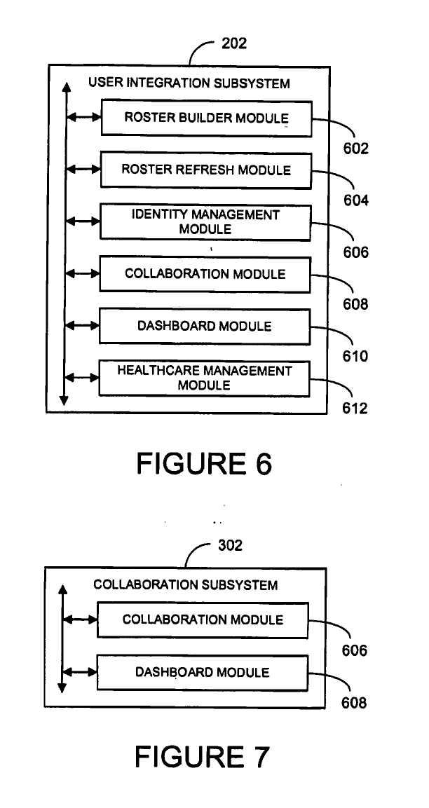

FIG. 6 illustrates an example user integration subsystem 202 that may be deployed in the provider device 112, the provisioning device 106, the collaborator device 102, or otherwise deployed in another system. One or more modules are included in the user integration subsystem 202 to enable a number of users of the entity to be able to use software provided by the software application provider. The modules of the user integration subsystem 202 that may be included are a roster builder module 602, a roster refresh module 604, an identity management module 606, a collaboration module 608, a dashboard module 610, and a healthcare management module 612. Other modules may also be included. In some embodiments, some of the functionality of the modules of the user integration subsystem 202 may be divided such that one or more devices of the system 100 have certain portions of the functionality and other devices of the system 100 have other portions of the functionality.

The roster builder module 602 creates the roster of the users associated with the entity that are to be brought online to be able to use the practice management software offered by the software application provider. The roster includes identification of the users and a variety of data and data types. The data and data types may include portions of the user data 110 and data associated with task completion of the users.

The roster builder module 602 may initiate the process of creating the roster by receiving group identification for a number of users to include on the roster. The group identification may be, by way of example, a physician group, a cost center (e.g., a department in a general ledger structure), an organization structure, association with a specific practice, job codes, job types, or the like. The group identification may be received from the collaborator, a device (e.g., the collaborator device 102), or may otherwise be received.

In some embodiments, the roster builder module 602 acts as a population segmentation tool that pulls the users that are associated with the group identification from all users that have information stored within the user data 110 and the credential data 114. Aside from the group identification, the roster builder module 602 acts as a population segmentation tool may be used to search for a specific user (e.g., based on a user's demographics).

Once the roster builder module 602 has received group identification, the roster builder module 602 may receive user information for the users that are associated with the group from the user database 108 and the credential database 112. The user information may be received by a push operation, a pull operation, or may otherwise be received. The roster builder module 602 may use GET PROOF or another procedure to obtain the user information from the user data 110 stored in the user database 108.

The roster builder module 602 may then write the identification of the users of the group and the received user information to the collaboration site 124. The information is used to populate the roster.

In some embodiments, the roster builder module 602 checks the security data 120 to determine whether a particular user is associated with the software application provider. For example, the user may be associated with the software application provider when the user exists within the security data 120. If the particular user is associated, additional information about the user may be transmitted to the collaboration site 124 for the creation and/or updating of the roster. In some embodiments, the association may be determined by querying the provider database 118 with the network identifier of the user.

In some embodiments, the network identifier is a login identifier to an active directory. The network identifier may be the same as the provider identifier. The network identifier may be used to run a query against the provider database 118. The result of the running the query is that it identifies whether the user is already associated with the software application provider (e.g., a preexisting user of the software application provider). If the user is already associated, the query also returns a security template and the provider identifier. By receiving the foregoing information, unnecessary scheduling of training for certain users and/or training of these users may be avoided.

Once the credential data 114 of the user is accessed, the roster builder module 602 may determine what type of credential the user has. For example, the user may be a physician or a RN. The determined credential may affect the type of access the user has in the EMR software.

In some embodiments, the roster builder module 602 establishes links to the user database 108 and the credential database 112 for the users that are associated with the group. In one embodiment, the links may be implemented as pointers.

The links enable the created roster to obtain updated user information. The links may be received by the collaboration site 124 instead of or in addition to the user information. The links may be used to update the user information as it changes over time. The links may be used as part of a synchronization process. By way of example, updated information in the user data 110 and/or the credential data 112 may be reflected on the roster.

In some embodiments, the relationship of the user with a number of different sources may be managed through linking. For example, linking may enable managing a physician relationship with the software application provider, a healthcare plan relationship with the software application provider, an employee relationship with the software application provider, or the like. The roster builder module 602 may be used to pull information from the various sources.

In some embodiments, the user data 110 and the credential data 114 are linked prior to performing at least some of the operations associated with the roster builder module 602.

Prior to writing user information to the collaboration site 124, roster builder module 602 may provision a roster on the collaboration site 124. The roster may be in the form of a table of a database, a spreadsheet, or may be in a different form. The roster may be created in accordance with a particular schema that includes a number of columns and data types. The schema may be the master template or a different schema. The user information, when written to the collaboration site 124, populates the roster with data.

The roster builder module 602 may write a first portion of the roster to the collaboration site 124. This information is prepopulated in the sense that this portion of the roster is written prior to collaborators or users performing certain actions (e.g., training or certification) that may affect the roster. The roster may then be updated or enriched based on certain actions performed by the users.

In some embodiments, the roster created by the roster builder module 602 is created based on a master template. The master template defines the structure of the roster. One or more rosters may be created based on the master template. The data of the roster is stored in the format of the master template. By use of the master template, the structure and the data types for the roster are known at the time of creation without further collaborator definition. The roster created based on the master template has a name and is populated with data of the users that were specified by the criteria defined by the collaborator. The name may be designated by the collaborator, automatically generated, or otherwise created.

In some embodiments, the master template is an active master template. The definition of the active master template may be expanded (e.g., by adding new columns) or refined. New rosters associated with the active master template may then be created based on the revised definition.

In some embodiments, the roster includes a listing of users that still need to complete some training or certification for a particular entity (e.g., a hospital). Once the roster is created, a number of different workflows can occur so that the training and certification of the users can be scheduled or otherwise planned.

In general, the functionality of the roster builder module 602 operates client-side (e.g., on the collaborator device 102). However, portions (e.g., a partial portion or an entire portion) of the functionality may be performed server-side (e.g., on the provisioning device 106). The functionality of the roster builder module 602 may otherwise be distributed (e.g., peer-to-peer).

In one embodiment, all or a portion of the functionality of the roster builder module 602 may be performed on the provider device 116. The software application provider may then control certain operations in place of the collaborator.

When users are added to or removed from the user data 110, the roster refresh module 604 transmits roster updates to communicate changes to the roster to the collaboration site 124. For example, new personnel may be hired into a facility, positions may be credentialed, personnel may lose credentialing, or the like. In some embodiments, the roster refresh module 604 determines whether there is new user information based on the user data 110, the credential data 114, or both. Once the new user information has been identified, the security data 120 may be checked to determine whether there is security data 120 associated with the new user. The collected information may then be written to the roster on the collaboration site 124.

In some embodiments, the refresh module 604 may perform all or a portion of the operations performed by the roster creation module 602 to revalidate the listing of users that are associated with a particular roster. By updating the roster with the changed user data, the roster can accurately reflect the amount of training and/or credentialing to still be performed.

When a new user is hired or an existing user has a status change in the user data 110, an interface brings the changed data into the collaboration site 124.

The identity management module 606 enables the collaborator to determine who a user is in the user database 108. The identity management module 606 uses the link to obtain information about the user from both the credential database 112 and the user database 108.

The collaboration module 608 enables a number of different people involved with the workflow of bringing the users associated with the entity online with the software application provider.

The dashboard module 610 provides a dashboard to various people (e.g., users and collaborators) to enable them to manage the progress of the users. The management may be just for one particular user, or may be for a number of different users.

In some embodiments, the dashboard module 610 accesses the roster, analyzes the roster, generates user metric information based on the analysis of the roster, and presents the user metric information. In some embodiments, the user metric information may reflect portions of users associated with the entity that have not completed tasks (e.g., training or certification) that they are or were expected to complete. For example, the user metric information may include a number and/or a percentage of users that have not scheduled training.

In some embodiments, one or a number of views are available to review information associated with the roster. A view defines what data associated with the roster that a particular user or collaborator is able to see. In general, a view enables the collaborator or user to view and/or update a subset of the data associated with the roster. The views may be available through the dashboard, through a graphical interface, or may otherwise be available. In some embodiments, the views support the workflow of brining users online with the software application provider.

In some embodiments, the collaborator has a default view and may select among a number of other available views. For example, in one view the collaborator can review all users regardless of the number of training items completed while in another view a subset of the users may be reviewed.

In one particular embodiment, a person accesses a view by logging into the collaboration device 122. The default view available to the person may differ from another person based on the respective roles of the people in the system 100. For example, a first user or collaborator may see columns A, B, and C while a second user or collaborator may see columns D, E, and F. The first user or collaborator may see a first set of users and the second user or collaborator may see a second, different set of users. The roster thereby may look different to various people depending on their roles within the system 100.

Example roles for collaborators include a security role that manages the master template, an implementation team role that performs roster and data validation and identifies specific desired elements (e.g., whether a particular user should be a super user), and a training team role inserts a date that a user has completed training. Other or different roles may be also be assigned.

By way of example, one or more custom views may be created for a particular template or a number of different templates. Each custom view is associated with a number of columns of the template. The assigned columns may be based on the tasks to be performed by the persons associated with the custom view. By excluding columns from the view, data not associated with the tasks to be performed by the persons may be excluded from the view. In some embodiments, excluding columns enables the persons to be able to more effectively work with data associated with their tasks.

In some embodiments, the views may act as a security layer. A collaborator may be able to see certain columns of data but may not be able to update them. The associated fields may thus been “read-only” fields to the person. In some embodiments, “read-only” fields and fields that the person may be able to update are distinguished in the user interface.

In some embodiments, the view acts as a filter that only displays to the user or collaborator tasks that have not yet been completed and/or users that have yet to complete certain tasks. For example, users that have yet to complete training are excluded from the view so that the person seeing the view can focus on the people that have yet to complete the training. The view may thus enable the collaborator to identify users that have not yet completed certain training or other tasks.

By way of example, the collaborator may select to view an implementation view. After the collaborator is verified to access the view, columns associated with implementation view of the applicable roster are automatically selected and data from these columns are presented to the user. The review of number of users associated with the applicable roster may also be narrowed based on the remaining tasks to be performed. Once some of the users of the roster perform their task, the next time the viewer logs into the collaboration site 124, the data associated with these users may not be viewable by the viewer.

When included, the healthcare management module 610 enables the healthcare practice associated with the entity to be managed. In some embodiments, the healthcare management module 612 is only deployed in the provider device 116 of the system 100. Once the users of the entity are brought online with the software application provider, the users are able to use the services of the software application provider. A portion for the services may be provided by the healthcare management module 610.

FIG. 7 illustrates an example collaboration subsystem 302 that may be deployed in the collaboration device 122, or otherwise deployed in another system. One or more modules are included in the collaboration subsystem 302 to collaborate the workflow used to bring a number of users online with the software application provider. While the collaboration subsystem 302 is shown with only the collaboration module 606 and the dashboard module 608, other modules may also be included. In some embodiments, some of the functionality of the modules of the collaboration subsystem 302 may be divided between the collaboration subsystem 302 and the user integration subsystem 202 deployed in another device.

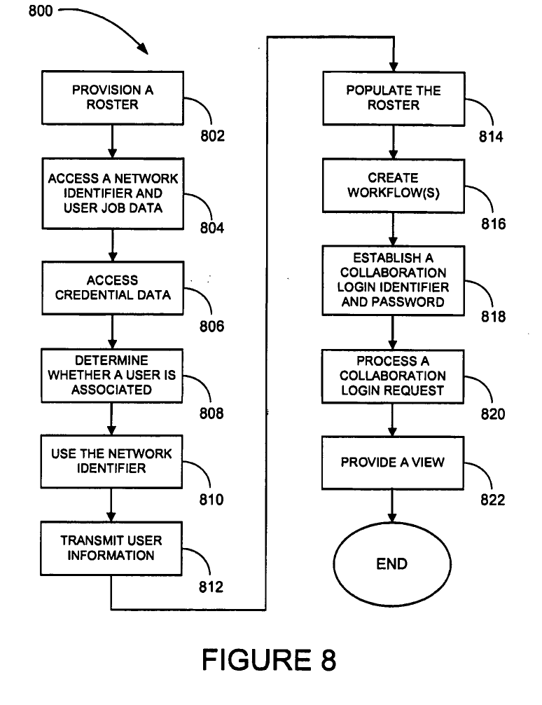

FIG. 8 illustrates a flow chart of a method 800 for administration initiation. In some embodiments, the method 800 is used to bring a number of users associated with an entity (e.g., a hospital) online with a software application provider.

A roster may be provisioned on the collaboration site 124 at operation 802. In some embodiments, a master template defining a number of fields of a roster may be accessed and the roster may be provisioned based on the master template.

A network identifier of a user and user job data of the user is accessed from the user database 108 at operation 804. The user may all be associated with an entity that is in or beginning the process of going live with the software application provider. In general, each user of the entity going online has his or her own network identifier.

In some embodiments, the network identifier and the user job data are accessed by transmitting a provisioning query over the network 104 to the user database 108 and receiving the network identifier of the user and user job data of the user in response to transmitting the query. The provisioning query may include, by way of example, a provider identifier, a facility identifier, and a department identifier.

In some embodiments, the user database 108 may be received from a third-party device prior to access of the network identifier of the user and user job data of the user. In one embodiment, the user database is converted into an integrated format.

The credential data 114 of the user is accessed from the credential database 112 at operation 806. In some embodiments, the credential data of the user is access from the credential database 112 using a link. In one embodiment, the link is based on the network identifier.

In some embodiments, a determination of whether the user is associated with the software application provider based on the network identifier may be made at operation 808. The determination may be made by receiving a reporting extract from the provider device 116 and determining whether the user is listed on the reporting extract.

At operation 810, the network identifier is used to access an administrative network identifier associated with the user, a status of a user administrative account associated with the user, an administrative user name associated with the user, and a security template identifier associated with the user. The administrative network identifier enables access to software provided by a software application provider. The security template identifier identifies a security access level of the user with the software application provider.

User information is transmitted to the collaboration site 124 at operation 812. The user information includes the network identifier of the user, the user job data of the user, the administrative network identifier associated with the user, and the security template identifier. The administrative network identifier enables access to services provided by the software application provider. The security template identifier identifies a security access level of the user with the software application provider.

In some embodiments, a link to the user information of the user is transmitted to the collaboration site 124. The link may be transmitted in addition to or instead of the user information.

The roster is populated on the collaboration site 124 at operation 814. In general, the roster is populated with the network identifier of the user, the user job data of the user, the administrative network identifier associated with the user, the security template identifier, and training task status of the user. In some embodiments, the roster is populated with the link to the user information.

At operation 816, a single workflow or multiple workflows may be created based on populating the roster.

At operation 818, a collaboration login identifier and collaboration password for the user may be established for the user. The collaboration login identifier may be the same identifier as the administrative network identifier associated with the user. The collaboration password may be the same password as an administrative password associated with the user.

At operation 820, a collaboration site login request of the user may be processed. A view to a portion of the roster may be provided in response to the collaboration site login request at operation 822 based on a role of the user.

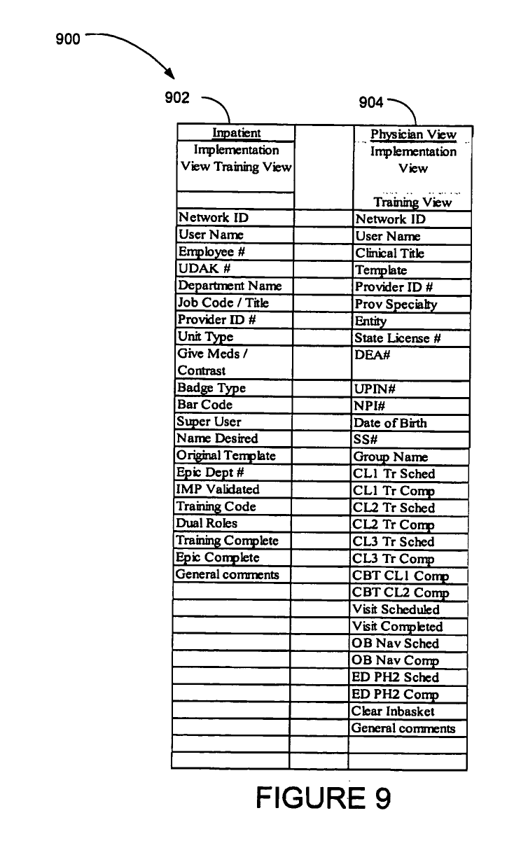

FIG. 9 illustrates example views 900 according to an example embodiment. The views 900 include two custom views—a custom view 902 for an inpatient and a custom view 904 for a physician. Each view shows applicable portions of the roster.

The custom view 902 shows a first user that is the inpatient a number of fields that includes, by way of example, a network identifier field, a user name field, an employee number field, a UDAK number field, a department name field, a job code/title field, a provider identifier number field, a unit type field, a give meds/contrast field, a badge type field, a bar code field, a super user field, a name desired field, an original template field, an EPIC department number field, an IMP validated field, a training code field, a dual roles field, a training complete field, an EPIC complete field, and a general comments field. Other or different fields may also be included. The first user will also see any associated data with the fields of the custom view 902.

The custom view 904 shows a second user that is the physician a number of fields that includes, by way of example, a network identifier field, a user name field, a clinical title field, a template field, a provider identifier number field, a provider specialty field, an entity field, a state license number field, a DEA number field, a UPIN number field, a NPI number field, a date of birth field, a social security (SS) number field, a group name field, a CL1 training scheduled field, a CL1 training completed field, a CL2 training scheduled field, a CL2 training completed field, a CL3 training scheduled field, a CL3 training completed field, a CBT CL1 completed field, a CBT CL2 completed field, a visit schedule field, a visit completed field, an OB nav scheduled field, an OB nav completed field, an ED PH2 scheduled field, a ED PH2 completed field, a clear inbasket field, and a general comments field. Other or different fields may also be included. The second user will also see any associated data with the fields of the custom view 904.

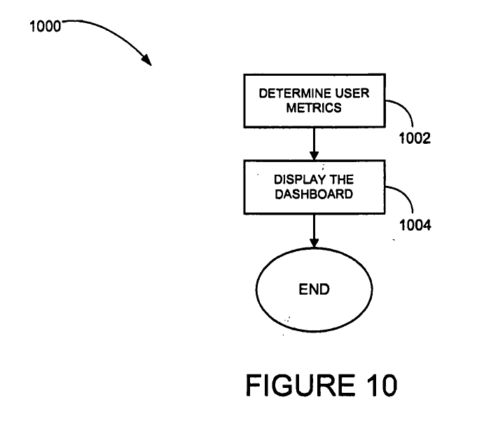

FIG. 10 illustrates a flow chart of a method 1000 for dashboarding. In some embodiments, the method 1000 is used to present a dashboard.

A determination of user metrics is made at operation 1002 based on the training task status of a number of users. The user metrics may be based on the training task status of the users associated with the roster. Examples of user metrics include a total number of physicians on the roster, percentage of physicians that have not scheduled training, percentage of physicians that have not completed everything, number and percentage of physicians that are scheduled for chart review, number and percentage of physicians that have completed chart review, number and percentage of physicians schedule for note writing, number and percentage of physicians that have completed note writing, number and percentage of physicians schedule for computerized physician order management (CPOM), number and percentage of physicians that have completed CPOM, number and percentage of physicians that have scheduled preferences setup, and number and percentage of physicians that have completed preferences setup.

A dashboard is generated at operation 1004 based on the user metrics. In one embodiment, a dashboard entry on the dashboard includes a user metric.

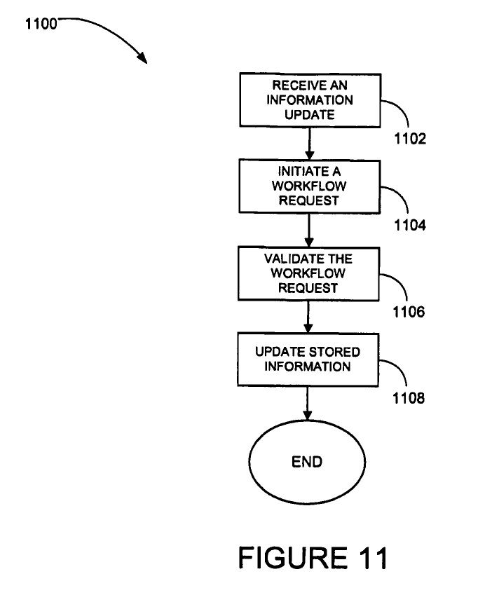

FIG. 11 illustrates a flow chart of a method 1100 for information updating. In some embodiments, the method 1100 is used to bring a number of users associated with an entity (e.g., a hospital) online with a software application provider.

An information update is received on the practice manager device 130 at operation 1102.

A workflow request is initiated at operation 1104 based on receipt of the information update.

Validation of the workflow request is received on the collaborator device 102 at operation 1106.

At operation 1108, a portion of information stored in the user database 110 is updated based on receipt of the validation.

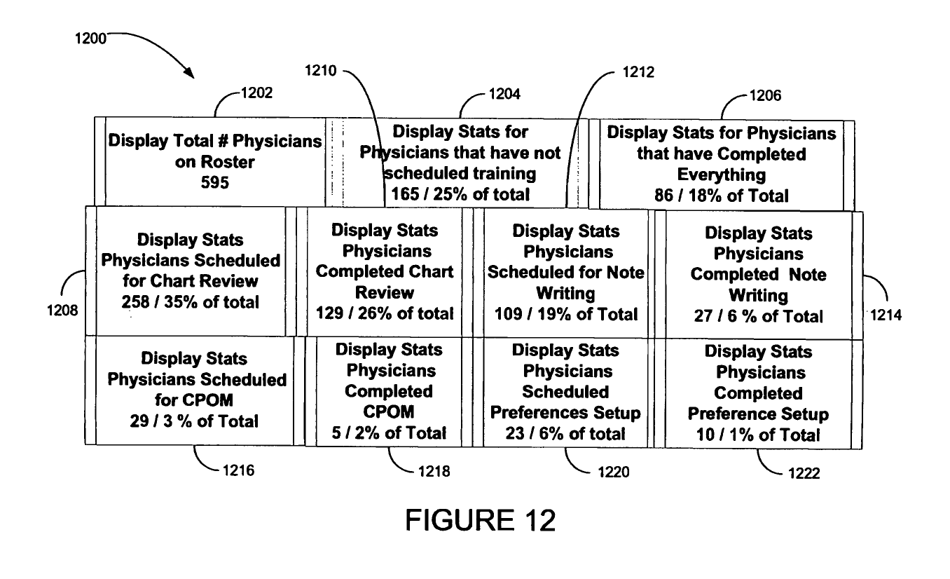

FIG. 12 is a user interface 1200 according to an example embodiment. The user interface 1200 is an example dashboard that includes a number of dashboard entries 1202-1222 that provide a user with access to a number of user metrics. As shown, a dashboard entry 1202 displays a total number of physicians on the roster, a dashboard entry 1204 displays percentage of physicians that have not scheduled training, a dashboard entry 1206 displays percentage of physicians that have not completed everything, a dashboard entry 1208 displays number and percentage of physicians that are scheduled for chart review, a dashboard entry 1210 displays number and percentage of physicians that have completed chart review, a dashboard entry 1212 displays number and percentage of physicians schedule for note writing, a dashboard entry 1214 displays number and percentage of physicians that have completed note writing, a dashboard entry 1216 displays number and percentage of physicians of physicians schedule for CPOM, a dashboard entry 1218 displays number and percentage of physicians that have completed CPOM, a dashboard entry 1220 displays number and percentage of physicians that have scheduled preferences setup, and a dashboard entry 1222 displays number and percentage of physicians that have completed preferences setup.

Any number of dashboard entries may be included on the dashboard 1200. Additional dashboard entries may have similar or different user metric information.

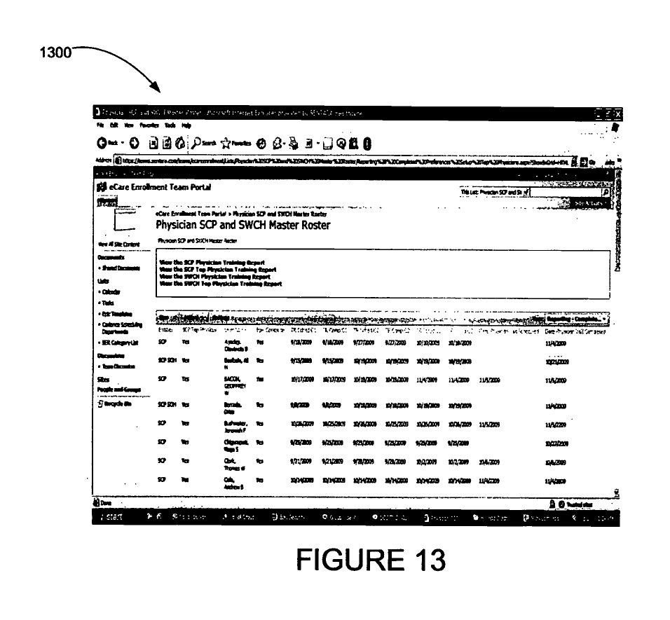

FIG. 13 is a screen shot of a user interface 1300 according to an example embodiment. The user interface 1300 enables the collaborator or the user to review data associated with the roster.

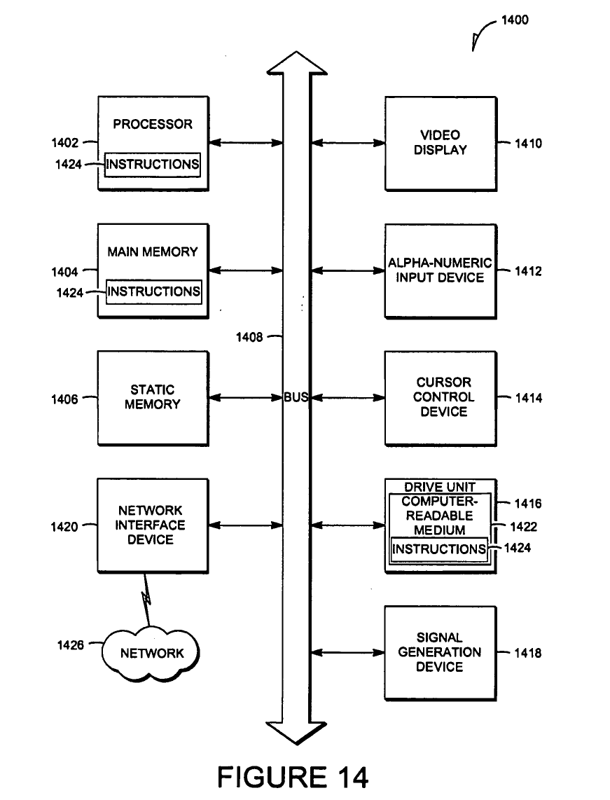

FIG. 14 shows a diagrammatic representation of machine in the example form of a computer system 1400 within which a set of instructions may be executed causing the machine to perform any one or more of the methods, processes, operations, applications, or methodologies discussed herein. The collaborator device 102, the provisioning device 106, the provider device 116, and/or the collaboration device 112 may include the functionality of at least one of the computer system 1400.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU) a graphics processing unit (GPU) or both), a main memory 1404 and a static memory 1406, which communicate with each other via a bus 1410. The computer system 1400 may further include a video display unit 1410 (e.g., a liquid crystal display (LCD), plasma display, or a cathode ray tube (CRT)). The computer system 1400 also includes an alphanumeric input device 1412 (e.g., a keyboard), a cursor control device 1414 (e.g., a mouse), a drive unit 1416, a signal generation device 1418 (e.g., a speaker) and a network interface device 1420.

The drive unit 1416 includes a machine-readable medium 1422 on which is stored one or more sets of instructions (e.g., software 1424) embodying any one or more of the methodologies or functions described herein. The software 1424 may also reside, completely or at least partially, within the main memory 1404 and/or within the processor 1402 during execution thereof by the computer system 1400, the main memory 1404 and the processor 1402 constituting machine-readable media.

The software 1424 may further be transmitted or received over a network 1426 via the network interface device 1420. While the machine-readable medium 1422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies shown in the various embodiments of the present invention. The term “machine-readable medium” shall accordingly be taken to include, but not be limited to, solid-state memories and optical and magnetic media, and physical carrier constructs.

Portions of the present description may appear to refer to users, collaborators, managers, providers, etc. as individuals. However, in many embodiments these references refer to devices, such as computer devices (e.g., the FIG. 14 device), that can electronically communicate with other devices.

Certain systems, apparatus, applications or processes are described herein as including a number of modules or mechanisms. A module or a mechanism can be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Aspects of the embodiments are operational with numerous other general purpose or special purpose computing environments or configurations can be used for a computing system. Examples of well known computing systems, environments, and/or configurations that may be suitable for use with the embodiments include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The communication systems and devices as described herein can be used with various communication standards to connect. Examples include the Internet, but can be any network capable of communicating data between systems. other communication standards include a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Wireless communications can occur over a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.14-based radio frequency network. Communications network 22 may yet further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection.

Aspects of the embodiments may be implemented in the general context of computer-executable instructions, such as program modules, being executed by a computer. Generally, program modules include routines, programs, objects, components, data structures, etc. that perform particular tasks or implement particular abstract data types. Aspects of the embodiments may also be practiced in distributed computing environments where tasks are performed by remote processing devices that are linked through a communications network. In a distributed computing environment, program modules may be located in both local and remote computer storage media including memory storage devices.

Thus, methods and systems for user integration have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing a network identifier of a user and user job data of the user from a user database;
accessing credential data of the user from a credential database;
using the network identifier to access an administrative network identifier associated with the user, a status of a user administrative account associated with the user, an administrative user name associated with the user, and a security template identifier associated with the user, the administrative network identifier enabling access to software provided by a software application provider, the security template identifier identifying a security access level of the user with the software application provider;
transmitting user information to a collaboration site, the user information including the network identifier of the user, the user job data of the user, the administrative network identifier associated with the user, and the security template identifier; and
populating a roster on the collaboration site with the network identifier of the user, the user job data of the user, the administrative network identifier associated with the user, the security template identifier, and training task status of the user with a plurality of training tasks.

2. The method of claim 1, wherein accessing credential data comprises:
accessing the credential data of the user from the credential database using a link, the link being based on the network identifier.

3. The method of claim 1, further comprising:
transmitting to the collaboration site a link to the user information of the user; and
populating the roster on the collaboration site with the link.

4. The method of claim 1, further comprising:
accessing a master template defining a plurality of fields of a roster,
provisioning a roster based on accessing the master template;
wherein populating the roster is based on creating the roster.

5. The method of claim 1, further comprising:
establishing a collaboration login identifier and collaboration password for the user, the collaboration login identifier being the same identifier as the administrative network identifier associated with the user, the collaboration password being the same password as an administrative password associated with the user.

6. The method of claim 1, further comprising:
creating a workflow based on populating the roster.

7. The method of claim 1, further comprising:
receiving group identification for a the roster; and
identifying the user and a plurality of additional users based on receipt of the group identification,
wherein accessing the network identifier and the user job data is based on identification of the user.

8. The method of claim 1, further comprising:
determining whether the user is associated with the software application provider based on the network identifier,
wherein using the network identifier is based on a determination that the user is associated with the software application provider.

9. The method of claim 8, further comprising:
receiving a reporting extract from a provider device associated with the software application provider,
wherein determining whether the user is associated with the software application provider includes determining whether the user is listed on the reporting extract based on the network identifier.

10. The method of claim 1, wherein accessing the network identifier and the user job data comprises:
transmitting a provisioning query over a network to the user database; and
receiving the network identifier of the user and user job data of the user in response to transmitting the query.

11. The method of claim 10, wherein the provisioning query includes a provider identifier, a facility identifier, and a department identifier.

12. The method of claim 10, further comprising:
receiving a plurality of additional network identifiers and the user job data of a plurality of additional users in response to transmitting the query,
a particular additional network identifier of the plurality of additional network identifiers being associated with a particular additional user of the plurality of additional users.

13. The method of claim 1, further comprising:
receiving the user database from a third-party device,
wherein accessing the network identifier and the user job data is based on receiving the user database.

14. The method of claim 13, further comprising:
converting the user database into an integrated format,
wherein accessing the network identifier and the user job data is based on converting the user database.

15. The method of claim 1, further comprising:
determining a plurality of user metrics based on the training task status of the user and a plurality of additional users associated with the roster;
generating a dashboard based on the plurality of user metrics, a particular dashboard entry on the dashboard including a user metric of the plurality of user metrics.

16. The method of claim 1, further comprising:
receiving an information update on a practice manager device;
initiating a workflow request based on receipt of the information update;
receiving validation of the workflow request on a collaborator device; and
updating a portion of information stored in the user database based on receipt of the validation.

17. The method of claim 1, wherein the user job data includes a user work location, a department associated with the user, a job code associated with the user, and a job title associated with the user.

18. The method of claim 1, further comprising:
processing a collaboration site login request of the user; and
providing a view to a portion of the roster based on a role of the user.

19. A machine-readable medium comprising instructions, which when implemented by one or more processors perform the following operations:
accessing a network identifier of a user and user job data of the user from a user database;
accessing credential data of the user from a credential database;
using the network identifier to access an administrative network identifier associated with the user, a status of a user administrative account associated with the user, an administrative user name associated with the user, and a security template identifier associated with the user, the administrative network identifier enabling access to software provided by a software application provider, the security template identifier identifying a security access level of the user with the software application provider;
transmitting user information to a collaboration site, the user information including the network identifier of the user, the user job data of the user, the administrative network identifier associated with the user, and the security template identifier; and
populating a roster on the collaboration site with the network identifier of the user, the user job data of the user, the administrative network identifier associated with the user, the security template identifier, and training task status of the user with a plurality of training tasks.

20. A system comprising:
at least one subsystem that accesses a network identifier of a user and user job data of the user from a user database;
at least one subsystem that accesses credential data of the user from a credential database;
at least one subsystem that uses the network identifier to access an administrative network identifier associated with the user, a status of a user administrative account associated with the user, an administrative user name associated with the user, and a security template identifier associated with the user, the administrative network identifier enabling access to software provided by a software application provider, the security template identifier identifying a security access level of the user with the software application provider;
at least one subsystem that transmits user information to a collaboration site, the user information including the network identifier of the user, the user job data of the user, the administrative network identifier associated with the user, and the security template identifier; and
at least one subsystem that populates a roster on the collaboration site with the network identifier of the user, the user job data of the user, the administrative network identifier associated with the user, the security template identifier, and training task status of the user with a plurality of training tasks.
